(19) United States
(12) Patent Application Publication
(10) Pub. No.: US 2005/0117219 A1
(43) Pub. Date: Jun. 2, 2005

(54) Iodine type polarizing film, method of producing the same and polarizer using the same

(75) Inventors: Hideki Hayashi, Niihama-shi (JP); Narutoshi Hayashi, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/752,018

(22) Filed: Jan. 7, 2004

(30) Foreign Application Priority Data
Jan. 16, 2003 (JP) 2003-008050

(51) Int. Cl. G02B 5/30

(52) U.S. Cl. 359/485

(57) ABSTRACT

An object of the present invention is to provide an iodine type polarizing film of a polyvinyl alcohol film showing improved durability, and a method of producing the polarizing film. There is provided an iodine type polarizing film of a polyvinyl alcohol film in/on which iodine is adsorbed and oriented, wherein the polyvinyl alcohol film contains a saponin. This polarizing film can be produced by a method of producing a polarizing film comprising uniaxially stretching a polyvinyl alcohol film, dyeing the polyvinyl alcohol film in an aqueous solution containing iodine, impregnating the polyvinyl alcohol film after dyeing in an aqueous solution containing boric acid, and washing with water after the impregnation in an aqueous solution containing boric acid, wherein a saponin is dissolved and contained in the aqueous solutions of the above-mentioned iodine dyeing or later steps.

### FIELD OF THE INVENTION

The present invention relates to an iodine type polarizing film, a method of producing the same, and an iodine type polarizer using the iodine type polarizing film.

### BACKGROUND OF THE INVENTION

A polarizing film is produced generally by allowing iodine which is a dichroic coloring matter, or a dichroic dye to be adsorbed and oriented in a polyvinyl film. On at least one surface of this polarizing film, a protective film made of triacetyl cellulose and the like is laminated with an adhesive layer to give a polarizing film, and the polarizing film is used for a liquid display and the like. Polarizing films using iodine as a dichroic coloring matter are called an iodine type polarizing film, and polarizing films using a dichroic dye as a dichroic coloring matter are called a dye type polarizing film. Of them, iodine type polarizing films show higher transmission and higher degree of polarization, namely, higher contrast as compared with dye type polarizing films, and consequently used widely. Iodine type polarizing films are superior to dye type polarizing film in optical properties as described above, however, inferior in optical durability to dye type polarizing film, and, for example, when an iodine type polarizing film is left under dry and heat condition, its transmission lowers and a polarizer having an iodine polarizing film is discolored.

On the other hand, with recent enlargement of the field liquid crystal displays used for and development of related technologies, requirements for polarizers are becoming higher. Specifically, polarizers having higher transmission and degree of polarization, for example, having higher contrast and excellent in heat resistance and wet heat resistance are required. In order to meet these requirements, JP 58-68008 A, for example, suggests a polarizing film obtained by uniaxially stretching a polyester resin and using this as a substrate. However, it is insufficient to obtain a polarizing film excellent in both polarization ability and durability, and further improvement is desired.

Further, JP 2000-35512 A suggests that a polyvinyl alcohol film dyed with iodine is impregnated in a boric acid aqueous solution containing a zinc ion and potassium iodide, allowing the polarizing film to contain zinc of specific amount to enhance durability of the polarizing film under high temperatures.

The present inventors have studied to enhance the durability of an iodine type polarizer made of a polyvinyl alcohol by means other than the above-mentioned patents. An object of the present invention is to provide an iodine type polarizing film having improved durability made of a polyvinyl alcohol, to provide a method of producing the same, further to provide a polarizer excellent in durability comprising this polarizing film.

The present inventors have studied and resultantly found that, in producing an iodine type polarizing film by stretching, dyeing with iodine, treating with boric acid after dyeing, and washing with water, if a saponin is dissolved and contained in at least any one of the aqueous solution containing iodine used for iodine dyeing, the aqueous solution containing boric acid used for boric acid treatment, and water used for washing, and if a polyvinyl alcohol film is treated with the aqueous solution containing a saponin, the polarizing film can contain a saponin, and that discoloration of the polarizing film under dry and heat condition can be suppressed. And then the invention was completed.

### SUMMARY OF THE INVENTION

Namely, according to the present invention, it provides an iodine type polarizing film of a polyvinyl alcohol film in/on which iodine is adsorbed and oriented, wherein the polyvinyl alcohol film contains a saponin.

Further, according to the present invention, it provides a method of producing such an iodine type polarizing film comprising uniaxially stretching a polyvinyl alcohol film, dyeing the polyvinyl alcohol film in an aqueous solution containing iodine and potassium iodide, impregnating the polyvinyl alcohol film after dyeing in an aqueous solution containing boric acid and washing with water after the impregnation, wherein a saponin is contained in at least one selected from the group consisting of the aqueous solution containing iodine and potassium iodide, the aqueous solution containing boric acid and water for washing.

Further, according to the present invention, it provides also an iodine type polarizer comprising a protective film and the above-mentioned iodine type polarizing film containing a saponin.

### DETAILED DESCRIPTION OF THE PREFERABLE EMBODIMENTS

Preferable embodiments of the present invention will be illustrated in detail below. An iodine type polarizing film is obtained by adsorbing and orientating iodine in a polyvinyl alcohol film. In the present invention, this polarizing film contains a saponin.

The polyvinyl alcohol film constituting a polarizing film is obtained by saponifying a polyvinyl acetate. The example of the polyvinyl acetate, include a homo-polymer of vinyl acetate, copolymers of vinyl acetate and other monomers copolymerizable with vinyl acetate, and the like. Other monomers copolymerized with vinyl acetate include unsaturated carboxylic acids, olefins, vinyl ethers, unsaturated sulfonic acids and the like. The degree of saponification of a polyvinyl alcohol is usually from about 85 to 100 mol %, preferably from about 98 to 100 mol %. This polyvinyl alcohol may be modified and for example, polyvinyl formal and polyvinyl acetyl modified with aldehydes, and the like can also be used. The degree of polymerization of a polyvinyl alcohol is usually from about 1000 to 10000, preferably from about 1500 to 5000.

Such a polyvinyl alcohol is formed into a film which is used for stretching. The method of forming a polyvinyl alcohol into film is not particularly restricted, and film-formation can be conducted by known methods. The thickness of the film made of a polyvinyl alcohol used for stretching is not particularly restricted, and for example, from about 5 μm to 150 μm, preferably from about 10 μm to 150 μm.

The iodine type polarizing film is produced by uniaxially stretching the polyvinyl alcohol film as mentioned above, dyeing the polyvinyl alcohol film with iodine to allow the iodine to be adsorbed, treating the iodine-adsorbed polyvinyl alcohol film with a boric acid aqueous solution, and washing with water after the treatment with a boric acid aqueous solution.

A uniaxially stretching may be conducted before dyeing with iodine, simultaneously with dyeing with iodine, or after dyeing with iodine. When uniaxially stretching is conducted after dyeing with iodine, this uniaxially stretching may be conducted before treatment with boric acid, or conducted during treatment with boric acid. Further, uniaxial stretching may be also conducted during these plural steps. For uniaxially stretching, stretching may be conducted uniaxially between rolls of different peripheral speeds, or stretching may be conducted uniaxially using a heat roll. Further, stretching may be dry stretching in which a film is stretched in air or wet stretching in which a film is stretched under condition of swelling the film with a solvent. The stretching ratio is usually from about 4 to 8 times.

Adsorption of iodine into a polyvinyl alcohol film is conducted by impregnating the polyvinyl alcohol film in an aqueous solution containing iodine and potassium iodide to dye the film. It is preferable that a polyvinyl alcohol film is impregnated in water before drying with a dye. The content of iodine in an aqueous solution containing iodine and potassium iodide is from about 0.01 to 1 part by weight per 100 parts by weight of water, and the content of potassium iodide is from about 0.5 to 20 parts by weight per 100 parts by weight of water. The temperature of this aqueous solution is from about 20 to about 40° C., and the impregnation time into this aqueous solution is from about 20 to about 1800 seconds.

Treatment with boric acid after dyeing with iodine is conducted by impregnating a polyvinyl alcohol film dyed with iodine in a boric acid aqueous solution. The content of boric acid in the boric acid aqueous solution is usually from about 2 to 15 parts by weight, preferably from about 5 to 12 parts by weight per 100 parts by weight of water. This boric acid aqueous solution preferably contains potassium iodide. When the boric acid aqueous solution contains potassium iodide, the amount of potassium iodide is usually 40 parts by weight or less, preferably 30 parts by weight or less per 100 parts by weight of water. The impregnation time into the boric acid aqueous solution is usually from about 60 to about 1200 seconds, preferably from about 150 to about 600 seconds, further preferably from about 200 to about 400 seconds.

A polyvinyl alcohol film after treatment with boric acid is usually washed with water. The washing with water is conducted by impregnating a polyvinyl alcohol film treated with boric acid in water. After washing with water, a drying treatment is performed, to obtain a polyvinyl alcohol film in/on which iodine is adsorbed and oriented, which is, an iodine type polarizing film.

In the present invention, a saponin is contained in an iodine type polarizing film. In this case, a saponin is introduced usually in any one of the above-mentioned dyeing in an aqueous solution containing iodine or the following steps. There can be adopted methods in which a saponin or saponin-containing substance is dissolved in at least one of an aqueous solution containing iodine and potassium iodide, an aqueous solution containing boric acid used for boric acid treatment, and water used for washing with water after boric acid treatment, in the process of producing an iodine-based polarization film as described above. Of them, a method is preferable in which a saponin or saponin-containing substance is dissolved in an aqueous solution containing boric acid to allow the saponin or saponin-containing substance to be contained in an iodine type polarizing film.

When a saponin or saponin-containing substance is dissolved in any stage, the amount of a saponin is usually from 0.01 to 60 parts by weight, preferably from about 0.5 to 30 parts by weight, more preferably from about 1 to 15 parts by weight per 100 parts by weight of water. When the amount of a saponin is less than 0.01 part by weight per 100 parts by weight of water, an effect of suppressing discoloration of the resulted polarization film under dry and heat condition, may not be sufficient.

A saponin is glycoside distributed in the plant kingdom, and is a generic name for compounds containing a poly-cyclic compound as an aglycone. It is also known that its aqueous solution shows a remarkable foaming property. A saponin is usually obtained as an extract from a plant containing this, and commercially available. The saponin or saponin-containing substance used in the present invention may be a coarse extract in the form of dry powder or a coarse extract in the form of liquid preparation containing an extraction solvent such as alcohols and the like, when the saponin or saponin-containing substance is contained in a polarizing film, as far as an effect of suppressing discoloration under dry and heat condition and the like is observed. The purity of the saponin is not particularly restricted, and it may be a purified substance. Additives such as stabilizers and preservatives and the like may be contained in small amount in the range not disturbing such an effect of a saponin.

Examples of the saponins include soy bean saponin, tea saponin (saponin of tea fruit), quillaja saponin, beat saponin (sugar beet saponin), soapberry saponin (soapberry extract powder), carrot saponin, bear grass saponin (bear grass foam extract), Eucommia ulcoides (tea) saponin, bastard saffron oil saponin, Panax ginseng saponin, bupleuri radix saponin, spinach saponin and the like. In addition, soyasapogenols A, B, C, D, E and F which are a component of soy bean saponin, and tomatine, alfalfasaponin, ginsengoside fraction 3 and 4, medicagenic acid,hederagenin, glycyrrhizin digitoning, lucerninc acid, zahnic acid and the like are also included in the saponin. Natural modified derivatives of these compounds distributed in the plant kingdom are also included in the saponin. The saponin used in the present invention is not necessarily limited to these specific examples. These saponins may be used each singly or in combination of two or more.

Of these saponins, tea saponin (saponin of tea fruit) and quillaja saponin are preferable, and particularly, quillaja saponin is preferable. Quillaja saponin is an extract from quillaja bark.

The content of a saponin in a polarizing film is from about 0.01 to 30 wt %, preferably 0.1 wt % or more and preferably 25 wt % or less. When the amount is too small, an effect of suppressing discoloration of the resulted polarizing film under dry and heat condition, may not be sufficient.

A saponin in a polarizing film of a polyvinyl alcohol film can be quantified by dissolving a polarizing film in a solvent, and analyzing its sample using reverse phase high performance liquid chromatography, according to, for example, methods described in Journal of the Science of Food and Agriculture, Vol. 80, p. 2063-2068(2000), Journal of Immunology, Vol. 146, p. 431-437(1991), and the like.

On thus obtained polarizing film containing a saponin, a protective film is laminated on one surface or both surfaces thereof, to give a polarizer. The protective film include, for example, films made of cellulose acetate resins such as triacetylcellulose and diacetylcellulose, acrylic resin films, polyester resin films, polyarylate resin films, polyether sulfone resin films, films made of cyclic polyolefin resins containing a cyclic olefin as a monomer such as norbornene, and the like. The thickness of the protective film is usually from about 10 μm to 200 μm.

On this polarizer, known various functional layers such as a reflection prevention layer, glare proof layer, hard coat layer and the like may be provided on one surface, namely, on an exposed surface of the protective film.

### EXAMPLES

The following examples will further illustrate the present invention, but do not limit the scope of the invention. Orthogonal hue shown in examples means hue of transmission light when straight polarization light crossing the transmission axis of a polarizing film is directed to the polarizing film.

### Example 1

A polyvinyl alcohol film having an average polymerization degree of about 2400, a saponification degree of 99.9 mol % or more, and a thickness of 75 μm was uniaxially stretched at a stretching ratio of 5 under dry condition, further impregnated in pure water of 60° C. for 1 minute while maintaining tension. Next, it was impregnated in an aqueous solution of iodine/potassium iodide/water of a weight ratio of 0.15/5/100 at 28° C. for 150 seconds. Thereafter, it was impregnated in an aqueous solution of saponin (quillaja saponin, obtained from Kishida Kagaku K.K.)/potassium iodide/boric acid/water of a weight ratio of 9.5/12/9.5/100 at 76° C. for 300 seconds. After washing with pure water of 15° C. for 3 seconds, it was dried at 50° C., to obtain apolarizing film in which iodine had been adsorbed and oriented in polyvinyl alcohol and further quillaja saponin had been adsorbed. The resulted polarizing film was subjected to evaluation of its durability under dry and heat condition according to the following method.

<Method of Evaluation of Durability>

First, the spectral transmission factor τ (λ) of the polarizing film was measured using a spectrophotometer “UV-2200” manufactured by Shimadzu Corp.]. From the resulted spectral transmission factor τ (λ), orthogonal hue L*, a* and b* were obtained. Next, this polarizing film was left under a dry atmosphere at 100° C. for 14 hours, and a durability test was conducted. Regarding this polarization film after the durability test, spectral transmission factor τ (λ) was measured again, and from this, orthogonal hue L*, a* and b* were obtained. From the orthogonal hue L*, a* and b* before and after the durability test, respective differences ΔL*, Δa* and Δb* were obtained according to the following formulae (1) to (3), further, the total color difference ΔE* was obtained according to the following formula (4).
ΔL*=(L*)_{after}−(L*)_{before} (1)
Δa*=(a*)_{after}−(a*)_{before} (2)
Δb*=(b*)_{after}−(b*)_{before} (3)

Here, before of subscript means a value before the durability test, and after of subscript means a value after the durability test.
ΔE*={Δ(L*)²+(Δa*)²+(Δb*)²}^{1/2} (4)

When the values of the difference Δb* of orthogonal hue b* and the total color difference ΔE* are larger, the degree of discoloration under dry and heat condition was judged to be larger. The result is shown in Table 1.

### Example 2

The same procedure as in Example 1 was conducted to produce a polarizing film except that dyeing with an aqueous solution containing iodine and potassium iodide was conducted at 28° C. for 360 seconds, saponin of tea fruit (obtained by Wako Pure Chemical Industries Ltd.) was used as a saponin, and the composition of a boric acid treatment bath after dyeing with iodine was an aqueous solution of the saponin of tea fruit/potassium iodide/boric acid/water of a weight ratio of 9.5/13/9.5/100. The resulted polarizing film was evaluated in the same manner as in Example 1, and the result is shown in Table 1.

### Comparative Example 1

The same procedure as in Example 1 was conducted to produce a polarizing film except that dyeing with an aqueous solution containing iodine and potassium iodide was conducted at 28° C. for 47 seconds, and a saponin was not added into the subsequent boric acid treatment bath. The resulted polarizing film was evaluated in the same manner as in Example 1, and the result is shown in Table 1.

TABLE 1

| | | The amount of saponin | | |
|---|---|---|---|---|
| | | in boric acid aqueous | | |
| Example No. | Saponin | solution | Δb* | ΔE* |
| Example 1 | Quillaja | 9.5 parts by weight | 0.37 | 1.57 |
| Example 2 | Tea fruit | 9.5 parts by weight | 0.44 | 1.74 |
| Comparative | — | — | 3.49 | 8.05 |
| example 1 | | | | |

*1: amount per 100 parts by weight of water

The iodine type polarizing film of the present invention shows prevention of deterioration after left under dry and heat condition, being excellent in durability.

1. An iodine type polarizing film of a polyvinyl alcohol film in/on which iodine is adsorbed and oriented, wherein the polyvinyl alcohol film contains a saponin.

2. The iodine type polarizing film according to claim 1, wherein the saponin is quillaja saponin.

3. The iodine type polarizing film according to claim 1, wherein the saponin is a saponin of tea fruit.

4. A method of producing an iodine type polarizing film comprising uniaxially stretching a polyvinyl alcohol film, dyeing the polyvinyl alcohol film in an aqueous solution containing iodine and potassium iodide, impregnating the polyvinyl alcohol film after dyeing in an aqueous solution containing boric acid, and washing the polyvinyl alcohol film with water after the impregnation, wherein a saponin is contained in at least one selected from the group consisting of the aqueous solution containing iodine and potassium iodide, the aqueous solution containing boric acid, and the water for washing.

5. The method according to claim 4, wherein the aqueous solution containing boric acid contains a saponin.

6. An iodine type polarizer comprising a protective film and the iodine type polarizing film according to any of claims 1 to 3.

7. The iodine type polarizer according to claim 6, wherein the protective film is on at least one surface of the iodine type polarizing film.
